(19) United States
(12) Patent Application Publication
(10) Pub. No.: US 2008/0232330 A1
(43) Pub. Date: Sep. 25, 2008

(54) Method for Ranging with Bandwidth Request Code

(75) Inventors: Nam Suk Lee, Daejeon-city (KR); Nam-Hoon Park, Daejeon-city (KR)

Correspondence Address: Jefferson IP Law, LLP, 1730 M Street, NW, Suite 807, Washington, DC, 20036, US

(73) Assignees: SAMSUNG ELECTRONICS CO., LTD., Suwon-city, Gyeonggi-do (KR); KT CORPORATION, Seongnam-si, Kyeonggi-do (KR); SK TELECOM CO., LTD, Seoul (KR); HANARO TELECOM, INC., Seoul (KR)

(21) Appl. No.: 12/088,330

(22) PCT Filed: Sep. 28, 2006
(86) PCT No.: PCT/KR2006/003894

§ 371 Date: Mar. 27, 2008

(30) Foreign Application Priority Data
Sep. 28, 2005 (KR) 10-2005-0090353
Sep. 28, 2006 (KR) 10-2006-0094586

(51) Int. Cl. H04J 13/00

(52) U.S. Cl. 370/335

(57) ABSTRACT

The present invention relates to a ranging method using a bandwidth request code. For this purpose, the present invention provides a ranging method that includes transmitting a bandwidth request code for requesting a bandwidth for uplink traffic transmission from a radio access station, receiving a CDMA_Allocation_IE of a UL_MAP that includes uplink radio resource information from the radio access station, adjusting a transmission parameter according to an adjustment value included in the CDMA_Allocation_IE when periodic ranging performance is checked through the CDMA_Allocation_IE, checking whether the adjusted transmission parameter has an optimum value, and resetting a timer for periodic ranging, and a CDMA_Allocation_IE structure of a UL_MAP for the same. According to the present invention, delay in uplink data transmission of a portable subscriber station can be reduced by including a ranging parameter for a bandwidth request code in a UL_MAP, and a downlink bandwidth can be efficiently used by a radio access station by eliminating a process of RNG_RSP transmission.

### TECHNICAL FIELD

The present invention relates to a ranging method using a bandwidth request code. More particularly, it relates to a ranging method that adjusts a transmission parameter by using a bandwidth request code for bandwidth allocation for uplink traffic transmission when a portable subscriber station transmits uplink traffic to a radio access station.

### BACKGROUND ART

A wireless portable Internet (WiBro: wireless broadband or HPI: high-speed portable Internet) system is a next generation communication system for further supporting mobility in addition to a short range data communication system that uses a fixed access point (AP) such as a conventional wireless local area network (LAN).

FIG. 1 is a schematic diagram of a wireless portable Internet system.

The wireless portable Internet system includes a portable subscriber station (PSS) 110, a radio access station (RAS) 120, an access control router (ACR) 130, an Internet Protocol (IP) network 140, a home agent (HA) 150, an authentication, authorization, and accounting (AAA) server 160, and an Internet 170.

The PSS 110 accesses a wireless portable Internet system and uses high-speed wireless Internet services by receiving/transmitting traffic data, and performs radio frequency (RF)/Intermediate frequency (IF) module and controller functions, control of a media access control (MAC) frame variation according to service characteristics and a propagation environment, a handoff, and authorization and encryption.

The RAS 120, as a base station of the wireless portable Internet system, wirelessly transmits data received from the ACR 130 to the PSS 110, and performs RF/IF module and controller functions, orthogonal frequency division multiple access (OFDMA)/time division duplex (TDD) packet scheduling and channel multiplexing functions, control of a media access control (MAC) frame variation according to service characteristics and a propagation environment, a high-speed traffic real-time control function, and a handover. In addition, the PSS 110 and the RAS 120 have a packet transmission modulation/demodulation function, a high-speed packet channel coding function, and a real-time modem control function.

The ACR 130 is a packet access router that connects multiple RASs 120, and performs a handover control function between the RASs 120, a handover between ACRs 130, a packet routing function, and an Internet access function. The ACR 130 accesses the IP network 140.

The IP network 140 is connected with the HA 150 and the AAA server 160, and transmits packet data forwarded from an external packet data service (e.g., the Internet 170) to the ACR 130.

When transmitting data from the Internet 170 to the PSS 100, the HA 160 routes externally transmitted data to the PSS 110 when using a mobile IP, and the MA server 170 performs billing of data services provided to the PSS 110 and authorization of a connection attempt of the PSS 110.

When the PSS 110 transmits uplink data in the wireless portable Internet system, a ranging process is performed in order to adjust transmission parameters such as transmit power, timing, and frequency offset so that the RAS 120 can receive the accurate uplink data.

The ranging process in the wireless portable Internet is divided into an initial access/hand-off ranging process, a periodic ranging process, and a bandwidth request ranging process.

The initial access/hand-off ranging is performed to adjust transmit power, timing, and frequency offset of the PSS 110, and starts an initial signal access process when the PSS 110 initially access the RAS 120 or tries to perform a handoff.

The periodic ranging process is periodically performed to adjust transmit power, timing, and frequency offset that vary in accordance with movement of the PSS 110.

FIG. 2 is a signal flowchart for describing the periodic ranging process of the wireless portable Internet system.

The PSS 110 of the wireless portable Internet system checks expiration of a T4 timer in order to perform the periodic ranging process. Herein, the T4 timer measures a maximum time that requires at least one resource allocation for uplink data, and checks a periodic ranging process.

When expiration of the T4 timer is confirmed, the PSS 110 transmits a periodic ranging code to the RAS 120. Herein, the periodic ranging code is a ranging request signal transmitted to the RAS 120 from the PSS 110 at the same time that the PSS 110 resets the T4 timer so as to perform the periodic ranging process with an interval of a single T4 timer.

When receiving the periodic ranging code, the RAS 120 adjusts transmit parameters including transmit power, timing, and frequency offset and transmits the adjusted transmit parameters to the PSS 110 through a ranging response (RNG_RSP) signal.

The PSS 110 adjusts transmit power, timing, and frequency offset by using the adjusted transmit parameter received from the RAS 120. Such a periodic ranging process is performed with the time interval of the T4 timer.

The bandwidth request ranging process by using a bandwidth request code is performed for a bandwidth request for transmission of uplink traffic generated in the PSS 110.

FIG. 3 shows a signal flowchart for describing bandwidth allocation and the bandwidth request ranging process by using a bandwidth request code in the wireless portable Internet system.

When the uplink traffic is generated in the PSS 110, the PSS 110 transmits a bandwidth request code to the RAS 120. When receiving the bandwidth request code, the RAS 120 generates an RNS_RSP signal that contains measured frequency offset, measured adjustment values for frequency offset, transmit power, and timing, and transmits the generated RNG_RSP signal to all RSSs connected to the RAS 120. When receiving the RNG_RSP that contains the adjustment values for frequency offset, transmit power, and timing, the PSS adjusts and transmits parameters (i.e., timing, transmit power, and frequency offset) accordingly, The RAS 120 transmits code division multiple access (CDMA) allocation information element (CDMA_Allocation IE) of uplink MAP (UP_MAP). Herein, the CDMA_Allocation_IE provides uplink radio resource information that includes uplink interval usage code (UIUC), a repetition code indication, a frame number index, a ranging code, a ranging symbol, a ranging subchannel, and a bandwidth request mandatory.

The PSS 110 performs ranging through the received CDMA_Allocation_IE, and transmits a bandwidth request header to the RAS 120 by using a bandwidth allocated to the UL-MAP. The RAS generates UL_MAP and DL_MAP allocated with bandwidths for uplink traffic of the PSS 110 through the received bandwidth request header and transmits the UL_MAP and DL_MAP to the PSS 110, and the PSS 110 transmits uplink traffic by using the bandwidths allocated to the UL_MAP and DL_MAP.

Such a bandwidth request ranging method using the bandwidth request code may generate delay since the PSS 110 that has transmitted a bandwidth request code needs to wait to receive an RNG-RSP signal and process the RNA_RSP signal for transmission of a bandwidth request header, thereby causing uplink traffic transmission delay.

In addition, when multiple PSSs connected to the RAS transmit bandwidth request codes for uplink traffic transmission, the RAS needs to broadcast a plurality of RNG-RSP signals to the multiple PSSs in response to the bandwidth request codes, and therefore it is difficult to efficiently use a downlink bandwidth. The bandwidth request code and a periodic ranging code are transmitted through the same uplink channel that is commonly used by all PSSs.

Accordingly, when the ranging process using a bandwidth request code is finished and a periodic ranging process is performed after the T4 timer has expired, the number of codes transmitted through the common uplink channel increases and the interference increases in the uplink ranging channel.

### DISCLOSURE

### Technical Problem

The present invention has been made in an effort to provide a ranging method using a bandwidth request code of a wireless portable Internet system having advantages of adjusting transmission parameters such as transmit power, timing, and frequency offset by using a bandwidth request code and a UL_MAP and providing a method for interworking with periodic ranging.

### Technical Solution

A ranging method according to an embodiment of the present invention is provided to a portable subscriber station that adjusts a transmission parameter by using a bandwidth request code, the ranging method including: (a) transmitting a bandwidth request code to a radio access station for requesting bandwidth allocation for uplink traffic transmission; (b) receiving a CDMA_Allocation_IE of a UL_MAP that includes information on an uplink radio resource from the radio access station; (c) adjusting the transmission parameter based on a transmission parameter adjustment value included in the CDMA_Allocation_IE when periodic ranging performance is checked through the CDMA_Allocation_IE; and (d) checking whether the adjusted transmission parameter has an optimum value and resetting a timer for periodic ranging.

A code division multiple access (CDMA) allocation information element (CDMA_Allocation_IE) structure of an uplink MAP (UL_MAP) according to an embodiment of the present invention is transmitted from a radio access station for ranging of a portable subscriber station that adjusts a transmission parameter by using a bandwidth request code. The CDMA_Allocation_IE structure includes a ranging parameter indicator for indicating whether the portable subscriber station performs a periodic ranging process; a power adjust that includes information on a transmit power adjustment value among the transmission parameters adjusted by the ranging of the portable subscriber station; a timing adjust that includes information on a timing adjustment value among the transmission parameters adjusted by the ranging of the portable subscriber station; an offset frequency adjust that includes information on a frequency offset adjustment value among the transmission parameters adjusted by the ranging of the portable subscriber station; and a ranging status that includes information on whether the transmission parameter adjusted by the ranging has an optimum value in the portable subscriber station.

A portable subscriber station according to another embodiment of the present invention adjusts a transmission parameter by performing ranging using a bandwidth request code. The portable subscriber station includes: a transmitting device for transmitting a bandwidth request code to request bandwidth allocation for uplink traffic transmission from a radio access station; a receiving device for receiving a code division multiple access (CDMA) allocation information element (CDMA_Allocation_IE) of an uplink MAP (UL_MAP) from the ratio access station, the CDMA_Allocation_IE of the UL_MAP including uplink radio resource information; an adjusting device for adjusting the transmission parameter according to a transmission parameter adjustment value included in the CDMA_Allocation_IE when it is determined that periodic ranging is performed; and a resetting device for checking whether the adjusted transmission parameter has an optimum value, and resetting a timer for periodic ranging.

A radio access station according to another embodiment of the present invention transmits a CDMA allocation information element (CDMA_Allocation_IE) of a UL_AMP for ranging according to a bandwidth request code transmitted from a portable subscriber station. The radio access station includes: a receiving device for receiving the bandwidth request code for requesting bandwidth allocation for uplink traffic transmission from the portable subscriber station; a determining device for determining a transmission parameter adjustment value to be transmitted to the portable subscriber station according to the receiving of the bandwidth request code; a generating device for generating the CDMA_Allocation_IE that includes the determined transmission parameter adjustment value; and a transmitting device for transmitting the generated CDMA_Allocation_IE to the portable subscriber station.

A recording medium according to another embodiment of the present invention is installed in a portable subscriber station that adjusts a transmission parameter by performing ranging using a bandwidth request code. The recording medium includes a function for transmitting a bandwidth request code for a bandwidth allocation request for uplink traffic transmission to a radio access station; a function for receiving CDMA_Allocation_IE of a UL_MAP that includes information on uplink radio resource from the radio access station; a function for adjusting a transmission parameter included in the CDMA_Allocation_IE when periodic ranging performance is checked through the CDMA_Allocation_IE; and a function for checking whether the adjusted transmission parameter has an optimum value, and resetting a timer for periodic ranging.

### DESCRIPTION OF DRAWINGS

FIG. 1 is a schematic configuration diagram of a wireless portable Internet system.

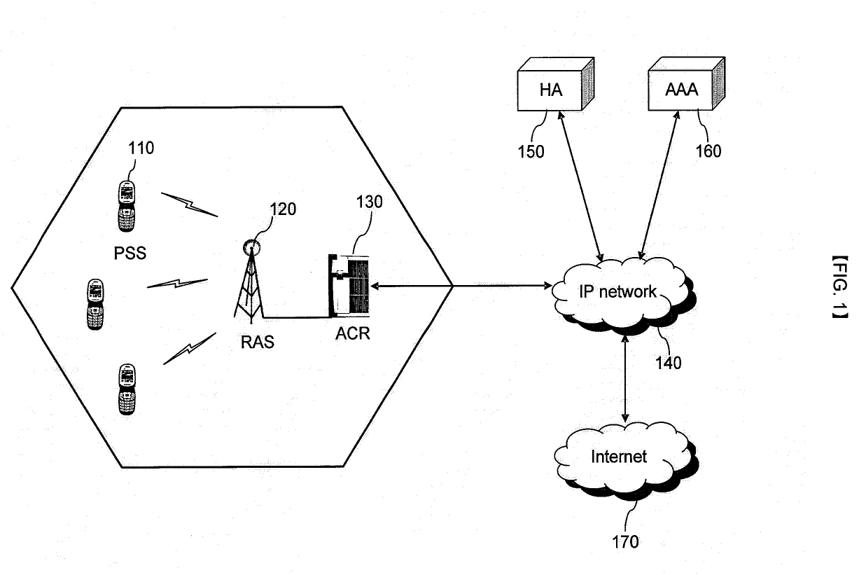

FIG. 2 is a signal flowchart of a periodic ranging process in the wireless portable Internet system.

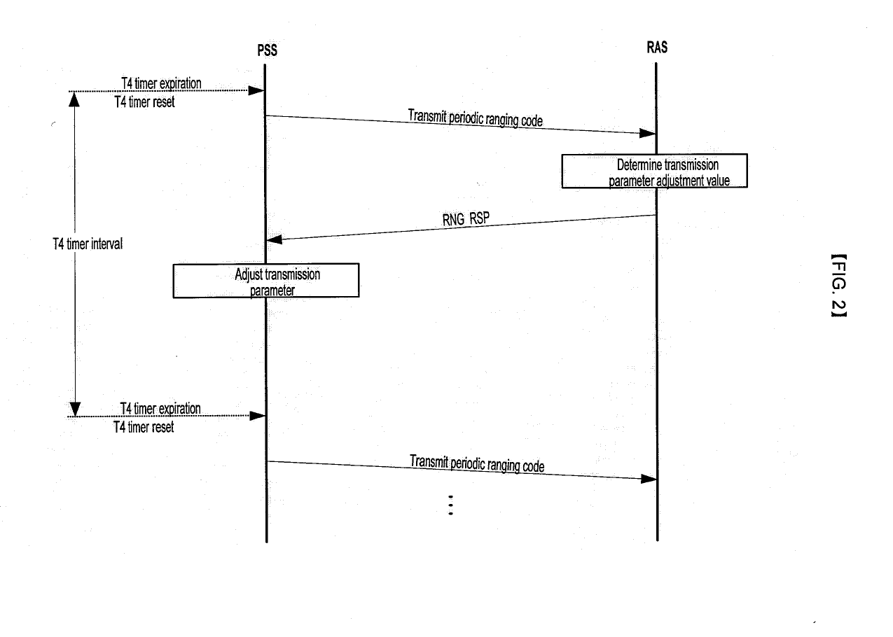

FIG. 3 is a signal flowchart of a bandwidth allocation and ranging process using a bandwidth request code in the wireless portable Internet system.

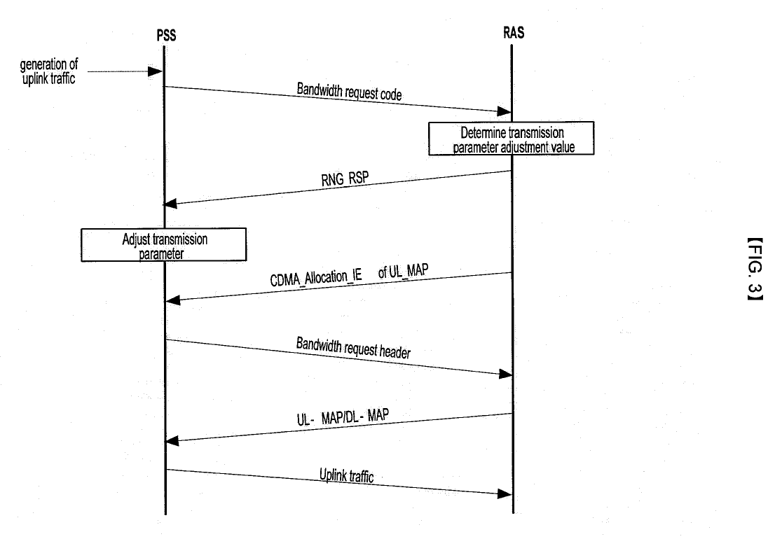

FIG. 4 is a signal flowchart of a bandwidth allocation and ranging process using a bandwidth request code according to an exemplary embodiment of the present invention.

FIG. 5 shows a structure of a CDMA_Allocation_IE of UP_MAP according to the exemplary embodiment of the present invention.

FIG. 6 is a flowchart of interworking of the bandwidth request ranging using the bandwidth request code and the periodic ranging according to the exemplary embodiment of the present invention.

### DETAILED DESCRIPTION OF THE EMBODIMENTS

An exemplary embodiment of the present invention will hereinafter be described in detail with reference to the accompanying drawings.

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, throughout this specification and the claims which follow, unless explicitly described to the contrary, the word “comprise” and variations such as “comprises” or “comprising” will be understood to imply the inclusion of stated elements but not the exclusion of any other elements.

Further, throughout this specification and the claims which follow, a module means a unit that performs a specific function or operation, and can be realized by hardware or software, or a combination of both.

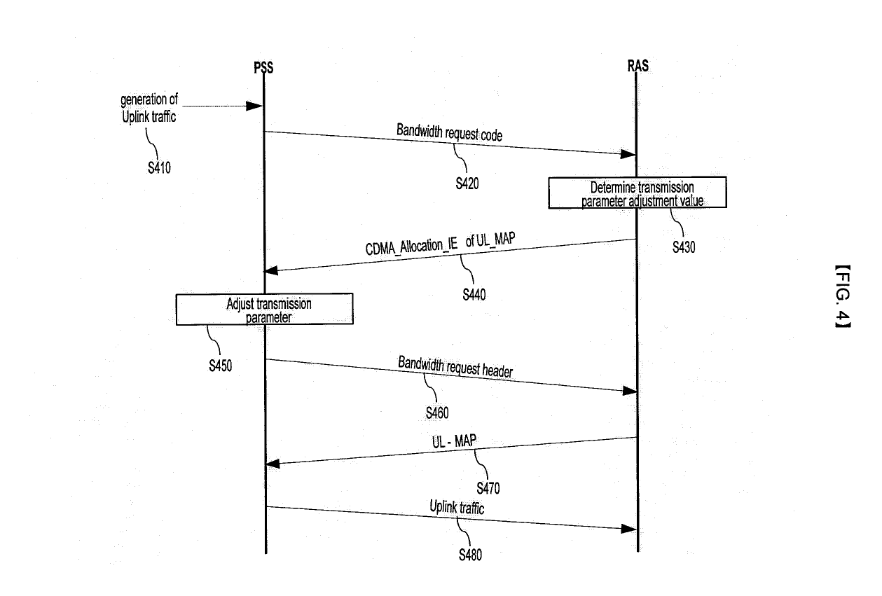

FIG. 4 is a signal flowchart of bandwidth allocation and bandwidth request ranging using a bandwidth request code according to an exemplary embodiment of the present invention.

When uplink traffic is generated by a portable subscriber station (PSS) 110 in step S410, the PSS 110 transmits a bandwidth request code to a radio access station (RAS) 120 for an uplink bandwidth request, in step S420.

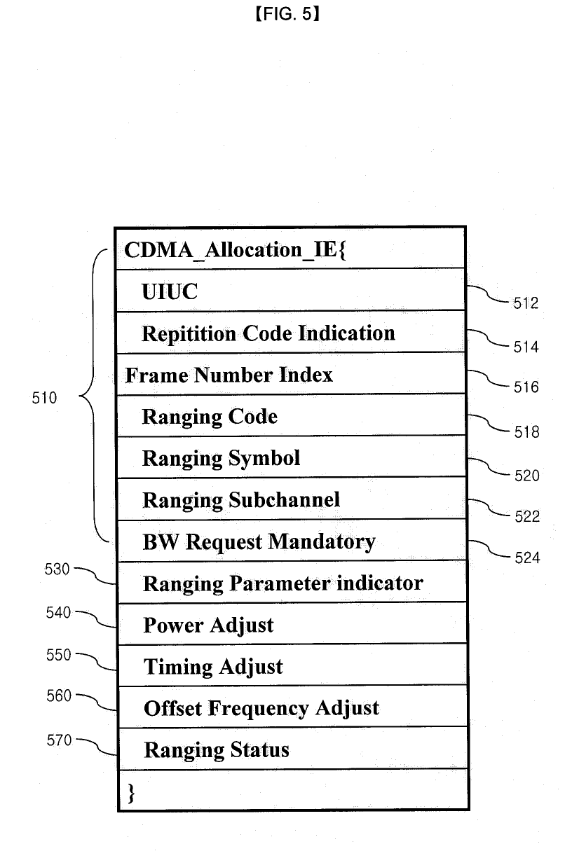

When receiving the bandwidth request code from the PSS 110, the RAS 120 adjusts transmission parameters including transmit power, timing, and frequency offset. When transmission parameter adjustment values are determined in step 430, the transmission parameter adjustment values are included in CDMA_Allocation_IE of a UL-MAP transmitted to the PSS 110 in step S440. In this case, bandwidth allocation information is also transmitted to the PSS 110 through the CDMA_Allocation_IE of the UL-MAP. For this purpose the CDMA_Allocation_IE of the UL-MAP must further include a constituent element for transmitting the transmission parameter adjustment values, unlike conventional CDMA_Allocation_IE. The constituent element of the CDMA_Allocation_IE of the UL_MAP according to the exemplary embodiment of the present invention will be described in more detail with reference to FIG. 5.

When receiving the transmission parameter adjustment values and the bandwidth allocation information through the CDMA_Allocation_IE, the PSS 110 performs a ranging process to adjust transmission parameters (i.e., transmit power, timing, and frequency offset) based on the received transmission parameter adjustment value, in step S450.

After finishing adjustment of the transmission parameters, the PSS 110 transmits a bandwidth request header to the RAS 120 by using a bandwidth allocated to the UL-MAP, in step S460.

The RAS 120 generates UL-MAP to which a bandwidth is allocated for transmission of uplink traffic of the PSS 110 through the received bandwidth request header and transmits the generated UL-MAP to the PSS 110 in step S470, and the PSS 110 transmits uplink traffic by using the bandwidth allocated to the UL-MAP, in step S480.

As described, the RAS 120 that has received the bandwidth request code transmits the bandwidth allocation information together with ranging adjustment values by using the CDMA_Allocation_IE of the UL-MAP rather than using RNG_RSP that has conventionally been used for transmission of ranging adjustment values, and accordingly the PSS 110 can omit an RNS_RSP receiving process, thereby reducing uplink traffic transmission delay.

Herein, the PSS 110 checks the CDMA_Allocation_IE of the UL-MAP received in step S440 to determine whether the periodic ranging process is performed.

FIG. 5 shows a CDMA_Allocation_IE structure of a UL_MAP according to the exemplary embodiment of the present invention.

The UL_MAP according to the exemplary embodiment of the present invention includes constituent elements 510 of a conventional CDMA_Allocation_IE, and further includes a ranging parameter indicator 530, a power adjust 540, a timing adjust 550, an offset frequency adjust 560, and a ranging status 570. The ranging parameter indicator 530 indicates whether the periodic ranging is performed, the power adjust 540 indicates a transmit power adjustment value, the timing adjust 550 indicates a timing adjustment value, the offset frequency adjust 560 indicates a frequency offset adjustment value, and the ranging status 570 indicates a ranging status.

The constituent elements 510 of the conventional CDMA_Allocation_IE include an uplink interval usage code (UIUC) 512 for indicating a code to be used in the UP-MAP, a repetition code indication 514 for indicating a repetition code used in allocated traffic, a frame number index 516 for indicating the number of frames to be used for uplink traffic transmission, a ranging code 518 for indicating a ranging code, a ranging symbol 520 for indicating a ranging symbol, and a ranging subchannel 522 for indicating a ranging subchannel, and a bandwidth request mandatory 524 for indicating an identifier for a bandwidth request.

A ranging parameter indicator 530 indicates whether the periodic ranging is performed. The CDMA_Allocation_IE according to the exemplary embodiment of the present invention includes ranging parameters and transmits them when the PSS 110 performs the periodic ranging, and the ranging parameters are not included in the CDMA_Allocation_IE when the periodic ranging is not performed in the PSS 110. According to this, the ranging parameter indicator 530 indicates whether the ranging parameters are included in the CDMA_Allocation_IE.

In this case, the ranging parameter indicator 530 may use only 1 bit, and it is set to “1” when the ranging parameters are included in the ranging parameters and is set to “0” when the ranging parameters are not included in the ranging parameter. However, the ranging parameter indicator 530 may be set to “1” when the ranging parameters are not included in the ranging parameter and set to “0” when the ranging parameters are included in the ranging parameters. In the following description, the ranging parameter indicator 530 is set to “1” when the ranging parameters are included in the ranging parameters and set to “0” when the ranging parameters are not included in the ranging parameter.

The PSS 110 checks the ranging parameter indicator 530 in the CDMA_Allocation_IE, and performs the periodic ranging process when the ranging parameter indicator 530 is “1”, and performs the bandwidth request ranging process by using a bandwidth request code when the ranging parameter indicator 530 is “0”.

When the ranging process is performed, the power adjust 540 includes information on transmit power among the transmission parameters adjusted by the PSS 110.

When the ranging process is performed, the timing adjust 550 includes information on a timing adjustment value among the transmission parameters adjusted by the PSS 110.

When the ranging process is performed, the offset frequency adjust 560 includes information on frequency offset among the transmission parameters adjusted by the PSS 110.

The ranging status 570 indicates a method of the periodic ranging process. Herein, the ranging status 570 may be represented as “Success” or “Continue”, or “1” or “0”. In the following description, the ranging status 570 is set to “Success” or “Continue”.

The ranging status 570 is set to “Success” when the transmit power, timing, and frequency offset for transmitting/receiving uplink data between the PSS 110 and RAS 120 are in the optimum state, and therefore, the PSS does not need to perform the periodic ranging process. Accordingly, when receiving the CDMA_Allocation_IE that includes the ranging status 570 set to “Success”, the RAS 120 resets a T4 timer which is a periodic ranging timer so as to prevent the periodic ranging process being performed and thus a ranging code is generated. When the T4 timer is reset, the periodic ranging process is not performed until the T4 timer has expired.

When the ranging status 570 is set to “Continue”, PSS 110 checks the necessity of performing the periodic ranging process for optimizing the transmission parameters. Accordingly, the PSS 110 resets the T4 timer, performs the periodic ranging process, and adjusts the transmit power, timing, and frequency offset to be in the optimal state.

By using the CDMA_Allocation_IE of the UL_MAP with the above constituent elements, the bandwidth request ranging process and the periodic ranging process can be jointly performed.

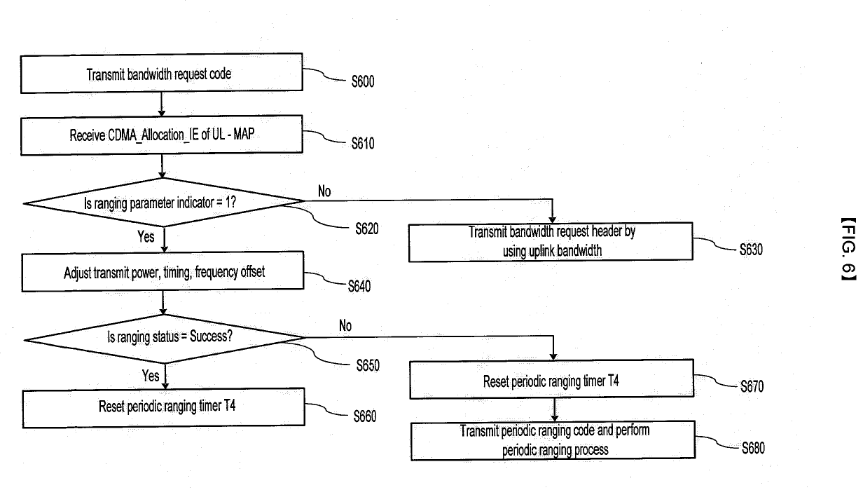

FIG. 6 is a flowchart of a joint process of the bandwidth request ranging process using the bandwidth request code and the periodic ranging process according to the exemplary embodiment of the present invention.

When the uplink traffic is generated, the PSS 110 transmits a bandwidth request code for an uplink bandwidth request to the RAS 120 in step S600.

According to receiving of the bandwidth request code from the PSS 110, the PSS 110 receives a CDMA_Allocation_IE of a UL_MAP from the RAS 120, in step S610. Herein, the CDMA_Allocation_IE includes adjusted transmission parameters that include transmit power, timing, and frequency offset.

When the CDMA_Allocation_IE of the UL-MAP is received, the PSS 110 checks a ranging parameter indicator that includes information on whether the periodic ranging is performed or not, in step S620. In this case, wherein the ranging parameter indicator 530 of the CDMA_Allocation_IE is set to “0”, it is determined that the periodic ranging is not performed and a bandwidth request header is transmitted by using the allocated uplink bandwidth, in step S630.

When the ranging parameter indicator 530 of the CDMA_Allocation_IE is set to “1” in step S620, it is determined that the periodic ranging is performed and the transmission parameters (transmit power, timing, frequency offset) are adjusted in accordance with adjustment values of the power adjust 540, the timing adjust 550, and the offset frequency adjust 560 in the CDMA_Allocation_IE, in step S640.

When the transmission parameters including the transmit power, the timing, and the frequency offset are terminated, the PSS 110 determines a method of the periodic ranging process according to a value of the ranging status 570. That is, whether the value of the ranging status 570 is set to “Success” is checked in step S650, and the T4 timer which is a periodic ranging timer is reset when the value of the ranging status 570 is set to “Success” and prevents the periodic ranging process from being performed, in step S660.

At this time, when the value of the ranging status 570 is set to “Continue”, the PSS 110 resets the T4 timer in step S670 and performs the periodic ranging process to transmit a period ranging code so as to adjust the transmit power, timing, and frequency offset to be in an optimum state, in step S680.

The above-described exemplary embodiment of the present invention may be realized by an apparatus and a method, but it may also be realized by a program that realizes functions corresponding to configurations of the exemplary embodiment or a recording medium that records the program. Such a realization can be easily performed by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

According to the present invention, delay in uplink data transmission of a portable subscriber station can be reduced by including a ranging parameter for the bandwidth request code in a UL_MAP, and a downlink bandwidth can be efficiently used by a radio access station by eliminating a process for transmitting an RNG_RSP for performing periodic ranging.

In addition, a periodic ranging process that is additionally performed when the uplink transmission parameter of the portable subscriber station in an optimum state can be adjusted by jointly performing bandwidth request ranging and periodic ranging, thereby reducing an uplink channel interference that occurs between a bandwidth request code and a periodic ranging code transmitted from a plurality of portable subscriber stations in an uplink ranging channel.

1. A ranging method for a portable subscriber station that adjusts a transmission parameter by using a bandwidth request code, the ranging method comprising:
(a) transmitting a bandwidth request code to a radio access station to request bandwidth allocation for uplink traffic transmission;
(b) receiving a CDMA_Allocation_IE of an uplink MAP (UL_MAP) that includes information on an uplink radio resource from the radio access station;
(c) adjusting the transmission parameter based on a transmission parameter adjustment value included in the CDMA_Allocation_IE when periodic ranging performance is checked through the CDMA_Allocation_IE; and
(d) checking whether the adjusted transmission parameter has an optimum value, and resetting a timer for periodic ranging.

2. The ranging method of claim 1, further comprising, when it is not checked that the transmission parameter has the optimum value in (d):
(e) transmitting a ranging request signal to the radio access station, and performing a periodic ranging process by using a transmission parameter value transmitted from the radio access station.

3. The ranging method of claim 1, wherein (b) comprises:
receiving a CDMA_Allocation_IE that includes:
a ranging parameter indicator for indicating whether the periodic ranging is performed;
a power adjust that includes information on a transmit power adjustment value among the transmission parameters;
a timing adjust that includes information on a timing adjustment value among the transmission parameters;
an offset frequency adjust that includes information on a frequency offset adjustment value among the transmission parameters; and
a ranging status that includes information on whether the adjusted transmission parameter has an optimum value.

4. The ranging method of claim 3, wherein in (c), when performance of the periodic ranging process is checked through the ranging parameter indicator, the values described in the power adjust, timing adjust, and offset frequency adjust are adjusted with the transmission parameter.

5. The ranging method of claim 3, wherein (b) comprises
receiving the CDMA_Allocation_IE that further includes:
an uplink interval usage code (UIUC) for indicating a code used in uplink traffic;
a repetition code indication for indicating a repeating code used for the uplink traffic;
a frame number index for indicating the number of frames used for transmission of the uplink traffic;
a ranging code for indicating a code used for the ranging;
a ranging symbol for indicating a symbol used for the ranging;
a ranging subchannel for indicating a subchannel used for the ranging; and
a bandwidth request mandatory for indicating an identifier for the bandwidth request.

6. The ranging method of claim 1, wherein in (c), when it is not checked through the CDMA_Allocation_IE that ranging is performed, the uplink traffic is transmitted by using an uplink bandwidth allocated through the CDMA_Allocation_IE.

7. A code division multiple access (CDMA) allocation information element (CDMA_Allocation_IE) structure of an uplink MAP (UP_MAP) transmitted from a radio access station for ranging of a portable subscriber station that adjusts a transmission parameter by using a bandwidth request code, the CDMA_Allocation_IE structure comprising:
a ranging parameter indicator for indicating whether the portable subscriber station performs a periodic ranging process;
a power adjust that includes information on a transmit power adjustment value among the transmission parameters adjusted by the ranging of the portable subscriber station;
a timing adjust that includes information on a timing adjustment value among the transmission parameters adjusted by the ranging of the portable subscriber station;
an offset frequency adjust that includes information on a frequency offset adjustment value among the transmission parameters adjusted by the ranging of the portable subscriber station; and
a ranging status that includes information on whether the transmission parameter adjusted by the ranging has an optimum value in the portable subscriber station.

8. The CDMA_Allocation_IE structure of claim 7, further comprising:
an uplink interval usage code for indicating a code used for uplink traffic;
a repetition code indication for indicating a repeating code used for the uplink traffic;
a frame number index for indicating the number of frames used for transmission of the uplink traffic;
a ranging code for indicating a code used for the ranging;
a ranging symbol for indicating a symbol used for the ranging;
a ranging subchannel for indicating a subchannel used for the ranging; and
a bandwidth request mandatory for indicating an identifier for a bandwidth request.

9. A portable subscriber station that adjusts a transmission parameter by performing ranging using a bandwidth request code, the portable subscriber station comprising:
a transmitting device for transmitting a bandwidth request code to request bandwidth allocation for uplink traffic transmission from a radio access station;
a receiving device for receiving code division multiple access (CDMA) allocation information element (CDMA_Allocation_IE) of an uplink MAP (UL_MAP) from the ratio access station, the CDMA_Allocation_IE of the UL_MAP including uplink radio resource information;
an adjusting device for adjusting the transmission parameter according to a transmission parameter adjustment value included in the CDMA_Allocation_IE when it is checked that a periodic ranging is performed; and
a resetting device for checking whether the adjusted transmission parameter has an optimum value, and resetting a timer for periodic ranging.

10. The portable subscriber station of claim 9, further comprising a device for transmitting a ranging request signal to the radio access station and performing a periodic ranging process by using a transmission parameter transmitted from the radio access station when it is determined that the adjusted transmission parameter does not have the optimum value.

11. A radio access station that transmits a code division multiple access (CDMA) allocation information element (CDMA_Allocation_IE) of an uplink MAP (UL_MAP) for ranging according to a bandwidth request code transmitted from a portable subscriber station, the radio access station comprising:
a receiving device for receiving the bandwidth request code for requesting bandwidth allocation for uplink traffic transmission from the portable subscriber station;
a determining device for determining a transmission parameter adjustment value to be transmitted to the portable subscriber station according to the receiving of the bandwidth request code;
a generating device for generating the CDMA_Allocation_IE that includes the determined transmission parameter adjustment value; and
a transmitting device for transmitting the generated CDMA_Allocation_IE to the portable subscriber station.

12. The radio access station of claim 11, wherein the CDMA_Allocation_IE comprises:
a ranging parameter indicator for indicating information on whether or not the ranging is performed;
a power adjust for indicating information on a transmit power adjustment value determined as the transmission parameter;
a timing adjust for indicating information on timing adjustment value determined as the transmission parameter;
an offset frequency adjust for indicating information on a frequency offset adjustment value determined as the transmission parameter; and
a ranging status for indicating information on whether the adjusted transmission parameter has an optimum value.

13. A recoding medium installed in a portable subscriber station that adjusts a transmission parameter by performing ranging using a bandwidth request code, the recoding medium comprising:
a function for transmitting a bandwidth request code for a bandwidth allocation request for uplink traffic transmission to a radio access station;
a function for receiving CDMA_Allocation_IE of an uplink MAP (UL_MAP) that includes information on uplink radio resource from the radio access station;
a function for adjusting a transmission parameter included in the CDMA_Allocation_IE when periodic ranging performance is checked through the CDMA_Allocation_IE; and
a function for checking whether the adjusted transmission parameter has an optimum value, and resetting a timer for periodic ranging.
